(19) United States
(12) Patent Application Publication
(10) Pub. No.: US 2026/0065410 A1
(43) Pub. Date: Mar. 5, 2026

(54) PROCESSING TCP PACKETS WITH A DPU AND GPU

(71) Applicant: NVIDIA Corporation, Santa Clara, CA (US)

(72) Inventor: Elena Agostini, Rome (IT)

(21) Appl. No.: 18/948,123

(22) Filed: Nov. 14, 2024

Related U.S. Application Data
(60) Provisional application No. 63/688,807, filed on Aug. 29, 2024.

(51) Int. Cl. G06T 1/20; G06T 1/60

(52) U.S. Cl. CPC G06T 1/20; G06T 1/60

(57) ABSTRACT

Apparatuses, systems, methods, and techniques to obtain information transmitted in data packets and store data, based at least in part on the information, in GPU memory. In at least one embodiment, the information is obtained and stored in GPU memory without using a central processing unit (CPU). In at least one embodiment, a data processing unit (DPU) recieves incoming data packets, stores information based at least in part on the data packets in DPU memory, and intiates a transfer directly to GPU memory. In at least one embodiment, the data packets are TCP data packets.

### CROSS-REFERENCE TO RELATED APPLICATIONS

The present application claims the benefit of U.S. Provisional Application No. 63/688,807, filed on August 29, 2024, entitled “PROCESSING TCP PACKETS WITH A DPU AND GPU,” the contents of which are incorporated by reference herein in their entirety.

### TECHNICAL FIELD

At least one embodiment pertains to the use of a data processing unit (DPU) operating in conjunction with a graphics processing unit (GPU) to receive and process data packets in accordance with transmission control protocol (TCP). At least one embodiment pertains to instructions to cause at least one DPU to receive and store data packets in GPU memory. For example, at least one embodiment, pertains to processors or computing systems used to receive data packets and store information contained in the data packets in memory associated with at least one parallel processing unit (“PPU”) according to various novel techniques described herein.

### BACKGROUND

In a conventional computer network, transmission control protocol (TCP) connections are handled by a host central processing unit (CPU). The host CPU must handle all aspects of communicating using TCP data packets, including managing the TCP software (SW) stack, analyzing the TCP headers, and reordering the packets to rebuild the original payload (e.g., when the host CPU is a component of an HTTP server receiving files). Processing TCP data packets may consume CPU cycles and prevent the host CPU from performing other important tasks. Additionally, moving data from the CPU memory to the GPU memory may take several milliseconds, contributing to increase the overall latency. The processing of TCP data packets can be improved.

### BRIEF DESCRIPTION OF DRAWINGS

FIG. 1 illustrates a functional block diagram of an example processing system, in accordance with at least one embodiment;

FIG. 2 illustrates a functional block diagram illustrating a data processing unit (DPU) receiving data packets and storing the data packets in GPU memory, in accordance with at least one embodiment;

FIG. 3 is a flowchart illustrating a method that may be performed by the system illustrated in FIGS. 1 and 2, in accordance with at least one embodiment;

FIG. 4A illustrates an example of a system that includes a driver and/or runtime including one or more libraries to provide one or more application programming interfaces (APIs), in accordance with at least one embodiment;

FIG. 4B is block diagram illustrating an example of a processor and modules, according to at least one embodiment;

FIG. 5A illustrates logic, according to at least one embodiment;

FIG. 5B illustrates logic, according to at least one embodiment;

FIG. 6 illustrates an example data center system, according to at least one embodiment; and

FIG. 7 is a block diagram illustrating a computer system, according to at least one embodiment.

### DETAILED DESCRIPTION

In at least one embodiment, a data processing unit (DPU) handles TCP processing and delivers data received in TCP packets (e.g., an HTTP file) directly to the GPU memory (e.g., via a direct memory access (DMA) transfer). For example, an application performed by at least one processor of the DPU may obtain data packets from a network interface (e.g., a network adapter), obtain data transmitted by those packets, store the data in host GPU memory, and set a flag indicating new data has been stored in the host GPU memory. One or more functions (e.g., a persistent kernel) performed by the GPU may poll the flag, and after determining that new data has been stored in the GPU memory, access the data, perform one or more processing operations with respect to the data, and send an acknowledgment to the DPU indicating that the data was successfully accessed. In at least one embodiment, using the DPU to handle the TCP data permits the GPU to process TCP data in real-time.

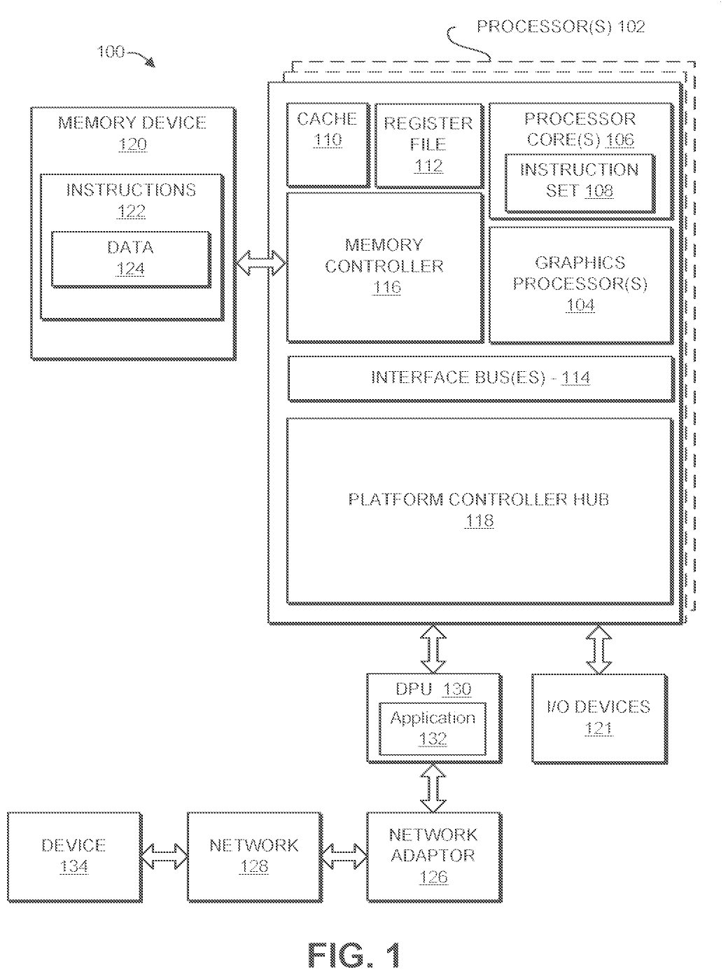

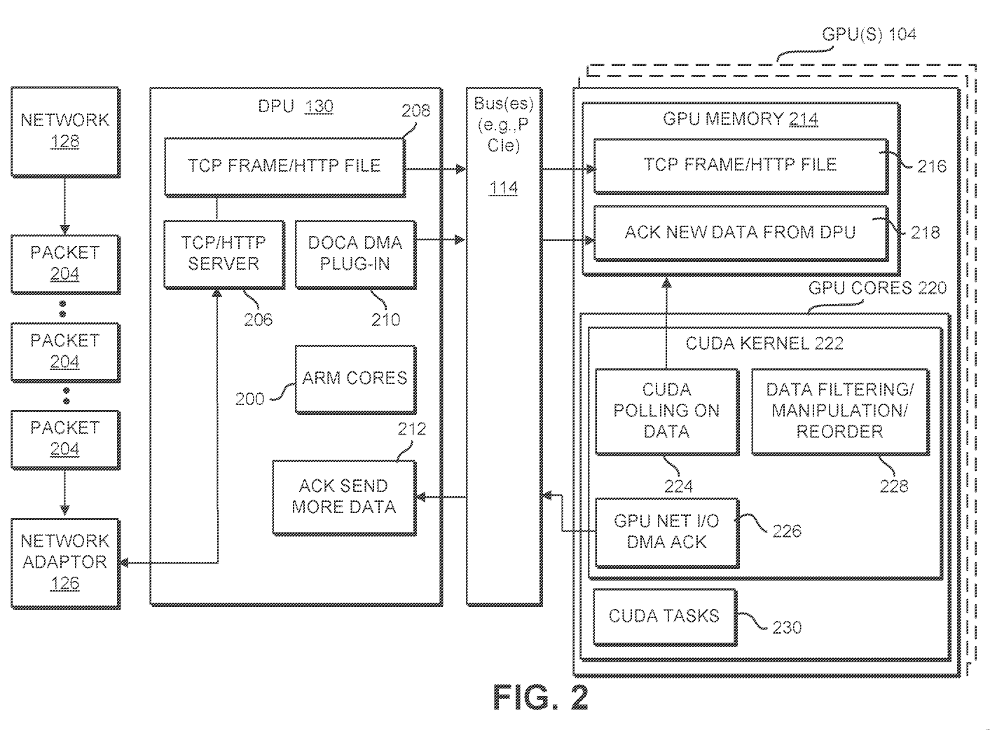

FIG. 1 illustrates a functional block diagram of an example processing system 100, in accordance with at least one embodiment. The processing system 100 includes at least one data processing unit (DPU) 130 to perform an application 132 that handles all of the TCP processing and delivers the data (e.g., an HTTP file) directly to GPU memory (e.g., GPU memory 214 illustrated in FIG. 2) accessible by one or more graphics processing units (“GPU(s)”) 104 (e.g., via a direct memory access (DMA) transfer). The DPU 130 may receive (e.g., via a network adapter 126) data (e.g., TCP data packets) from a sender device (e.g., device 134) connected to a network 128 and process that incoming data (e.g., store it in the GPU memory 214). The DPU 130 may receive data from the GPU(s) 104 and send that data (e.g., as TCP data packets via the network adapter 126) to a recipient device (e.g., device 134) connected to the processing system 100 by the network 128.

In at least one embodiment, the processing system 100 includes one or more processors 102 that may include the GPU(s) 104, and may be a single processor desktop system, a multiprocessor workstation system, or a server system having a large number of processor(s) 102 and/or processor cores 106. For example, the processing system 100 may implement one or more computing devices, one or more network devices (e.g., computing devices, switches, routers, aggregators, telemetry servers, etc.), one or more sensors, a data center, a cloud computing system, and/or the like.

In at least one embodiment, the processor(s) 102 each include one or more processor cores 106 to process instructions (e.g., instructions 122) which, when executed, perform operations for system and/or user software. In at least one embodiment, each of the processor core(s) 106 is configured to process an instruction set 108. In at least one embodiment, the instruction set 108 may facilitate Complex Instruction Set Computing (“CISC”), Reduced Instruction Set Computing (“RISC”), or computing via a Very Long Instruction Word (“VLIW”). In at least one embodiment, the processor core(s) 106 may each process a different instruction set 108, which may include instructions to facilitate emulation of other instruction sets. In at least one embodiment, the processor core(s) 106 may also include other processing devices, such as a digital signal processor (“DSP”).

In at least one embodiment, each of the processor(s) 102 includes cache memory (“cache”) 110. In at least one embodiment, each of the processor(s) 102 can have a single internal cache or multiple levels of internal cache. In at least one embodiment, cache memory is shared among various components of each of the processor(s) 102. In at least one embodiment, a register file 112 is additionally included in each of the processor(s) 102 which may include different types of registers for storing different types of data (e.g., integer registers, floating point registers, status registers, and an instruction pointer register). In at least one embodiment, the register file 112 may include general-purpose registers or other registers.

In at least one embodiment, the processor(s) 102 are coupled with one or more interface buses 114 to transmit communication signals such as address, data, or control signals between the processor(s) 102 and other components in the processing system 100. In at least one embodiment, the interface bus(es) 114 can include at least one processor bus, such as a version of a Direct Media Interface (“DMI”) bus. In at least one embodiment, the interface bus(es) 114 is/are not limited to DMI bus(es), and may include one or more Peripheral Component Interconnect (“PCI”) buses (e.g., PCI Express (“PCIe”) bus(es)), one or more memory buses, or other types of interface buses. In at least one embodiment, the processor(s) 102 include an integrated memory controller 116 and a platform controller hub (“PCH”) 118. In at least one embodiment, the memory controller 116 facilitates communication between a memory device 120 and other components of the processing system 100, while the PCH 118 provides connections to Input/Output (“I/O”) devices 121, such as a keyboard, mouse, data storage device, and display unit (not shown), and the network adapter 126.

In at least one embodiment, the memory device 120 can be a dynamic random access memory (“DRAM”) device, a static random access memory (“SRAM”) device, flash memory device, phase-change memory device, or some other memory device having suitable performance to serve as processor memory. In at least one embodiment, the memory device 120 can operate as system memory for the processing system 100, to store instructions 122 and data 124 for use when the processor(s) 102 execute(s) an application or process. In at least one embodiment, the memory controller 116 couples with the GPU(s) 104 in the processor(s) 102 to perform graphics and media operations.

In at least one embodiment, the network adapter 126 (e.g., NVIDIA ConnectX) provides an interface with the network 128. In at least one embodiment, the network adapter 126 controls the interaction between the DPU 130 and the network 128, such as a data center network, and/or the Internet. In at least one embodiment, the interface bus(es) 114 may include one or more PCI buses (e.g., implemented in accordance with PCIe Gen 5), which is/are connected to at least one connector that provides an interface between the PCI bus(es) and the DPU 130.

A TCP stack refers to various layers of a communication protocol similar to layers defined by an Open Systems Interconnection (OSI) model. The TCP stack includes an application layer, transport layer, network access layer, network interface layer, and a hardware layer. In at least one embodiment, the DPU 130 implements some or all of the various layers of the TCP stack.

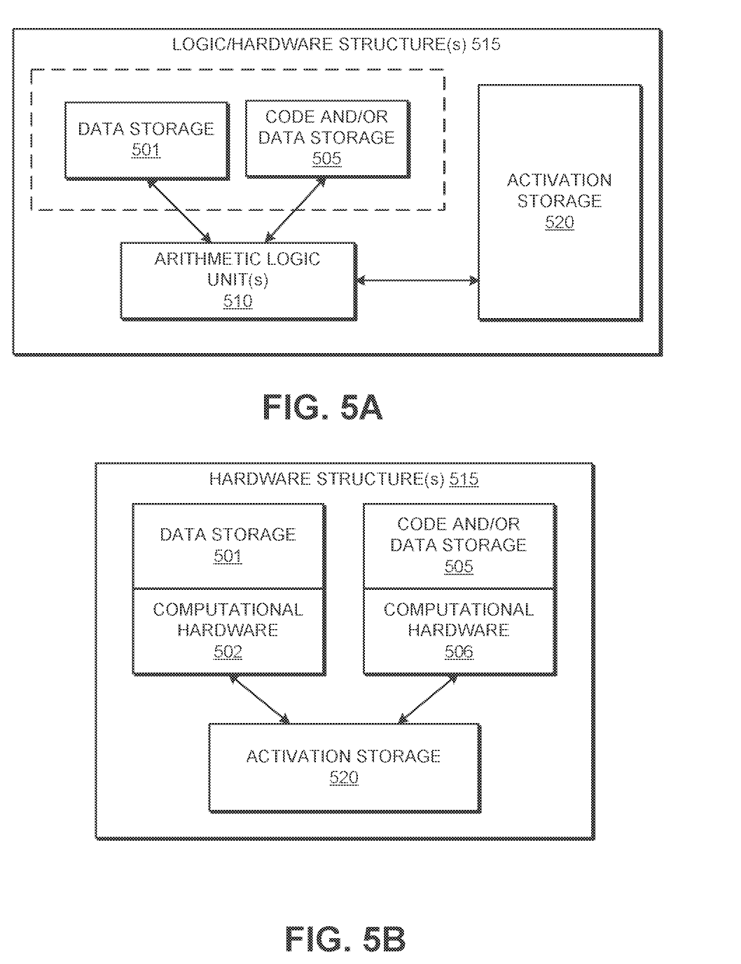

In at least one embodiment, at least a portion of the processing system 100 is implemented using at least a portion of any system(s) depicted in and/or described with respect to FIGS. 5-7. In at least one embodiment, at least a portion of the processing system 100 is used to implemented at least a portion of any system(s) depicted in and/or described with respect to FIGS. 5-7.

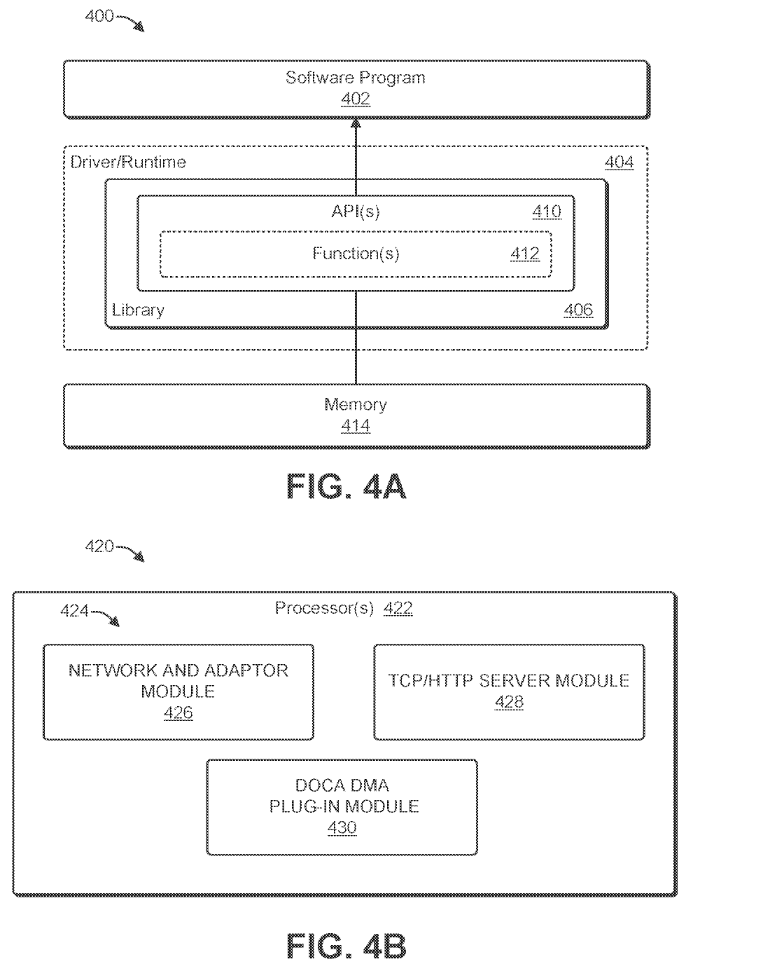

FIG. 2 illustrates a functional block diagram illustrating the DPU 130 receiving data packets 204 (e.g., TCP packets) and storing the data packets 204 in the GPU memory 214, in accordance with at least one embodiment. In FIG. 2, the DPU 130 interacts with the GPU(s) 104. In at least one embodiment, the DPU 130 is implemented with an advanced RISC machine (ARM) architecture. The DPU 130 may include processor(s) (e.g., processor(s) 422 illustrated in FIG. 4B), which may be implemented using one or more ARM cores 200. TCP stack management may be handled by at least one of the processor(s) (e.g., one of the ARM core(s) 200) of the DPU 130. The processor(s) of the DPU 130 may also perform other tasks normally handled by the host CPU (e.g., one or more of the processor(s) 102), such as analysis of the TCP headers, reordering of the packets to reassemble the packets to produce the original payload, and transfer of the packets into GPU memory. Because the data packets 204 may be reassembled into TCP file segments or files by the DPU 130, these file segments or files may be transferred from the DPU 130 to the GPU memory 214 using DMA transfers. In at least one embodiment, at least a portion of at least one of the processor(s) of the DPU 130 is implemented using at least a portion of any system(s) depicted in and/or described with respect to FIGS. 5-7. In at least one embodiment, at least a portion of at least one of the processor(s) of the DPU 130 is used to implemented at least a portion of any system(s) depicted in and/or described with respect to FIGS. 5-7.

The DPU 130 includes memory (e.g., one or more non-transitory processor-readable medium) to store processor executable instructions (e.g., stored in modules 424 illustrated in FIG. 4B) that when executed by the processor(s) (e.g., the processor(s) 422 illustrated in FIG. 4B) of the DPU 130 implement the application 132, and/or other functionality. By way of additional non-limiting examples, the memory (e.g., one or more non-transitory processor-readable medium) of the DPU 130 may be implemented, for example, using volatile memory (e.g., dynamic random-access memory (“DRAM”)) and/or nonvolatile memory (e.g., a hard drive, a solid-state device (“SSD”), and/or the like). The memory of the DPU 130 may include memory 208, which may store the data packets 204 and/or data obtained from the data packets 204 (e.g., a TCP frame and/or HTTP file). In at least one embodiment, at least a portion of the memory of the DPU 130 is implemented using at least a portion of any system(s) depicted in and/or described with respect to FIGS. 5-7. In at least one embodiment, at least a portion of the memory 110 is used to implemented at least a portion of any system(s) depicted in and/or described with respect to FIGS. 5-7.

The processor(s) (e.g., one of the ARM core(s) 200) of the DPU 130 may include one or more circuits that perform at least a portion of the instructions stored in the memory of the DPU 130. The processor(s) of the DPU 130 may include one or more parallel processing units (“PPU(s)”) 130, such as one or more GPU(s), and/or the like. The processor(s) of the DPU 130 may be implemented, for example, using one of the ARM core(s) 200, a main central processing unit (“CPU”) complex, one or more microprocessors, one or more microcontrollers, the PPU(s) 130 (e.g., GPU(s)), one or more DPU(s), one or more arithmetic logic units (“ALU(s)”), and/or the like.

The processor(s) and/or the memory of the DPU 130 may communicate with one another over one or more connections or buses 240, such as a Peripheral Component Interconnect Express (“PCIe”) connection (or bus), and/or the like. In at least one embodiment, at least a portion of these bus(es) 240 is implemented using at least a portion of any system(s) depicted in and/or described with respect to FIGS. 5-7. In at least one embodiment, at least a portion of the connection(s) 118 is used to implemented at least a portion of any system(s) depicted in and/or described with respect to FIGS. 5-7.

In at least one embodiment, at least a portion of the DPU 130 is implemented using at least a portion of any system(s) depicted in and/or described with respect to FIGS. 5-7. In at least one embodiment, at least a portion of the DPU 130 is used to implemented at least a portion of any system(s) depicted in and/or described with respect to FIGS. 5-7.

The application 132 may implement a communication interface (e.g., a TCP/HTTP server 206) and/or data transfer functionality (e.g., DMA functionality implemented by a Data Center Operations and Control Architecture (DOCA) DMA Plug-In 210). In operation, the network adapter 126 communicates with the network 128 to receive the plurality of incoming data packets 204 (e.g., TCP packets). In at least one embodiment, the network adapter 126 uses one or more application programming interfaces (APIs) to access one or more Linux sockets to interact with the network 128 and thus send and receive packets. In at least one embodiment, the communication interface (e.g., the TCP/HTTP server 206, such as NGINX) processes the incoming data packets 204 and reorders them, if necessary, to reassemble them into the original TCP frame and/or the original HTTP file and transfer the reassembled packets to the memory 208 for temporary storage. The assembled frames/file are stored in the memory 208 to await transfer.

In at least one embodiment, the data transfer functionality (e.g., implemented by the DOCA DMA Plug-In 210) controls transfer of the data from the memory 208 to the GPU memory 214 associated with the GPU(s) 104. In at least one embodiment, the data transfer functionality (e.g., implemented by the DOCA DMA Plug-In 210) detects a new HTTP packet/file is ready and triggers a data transfer from the memory 208 to the GPU memory 214 associated with the GPU(s) 104. In at least one embodiment, the data transfer is handled by a DMA engine (not shown) in the DPU 130. The DMA engine may be a component of the data transfer functionality and/or used thereby. In at least one embodiment, the data transfer is a DMA data transfer accomplished via the bus(es) 240 (e.g., one or more PCIe interface bus). Following the transfer, an acknowledgement (“ACK”) signal 212 and/or a request for the DPU 130 to send more data is received by the DPU 130 from the GPU(s) 104.

In at least one embodiment, the data transfer functionality (e.g., implemented by the DOCA DMA Plug-In 210) stores the transferred data in the GPU memory 214, which may be dedicated memory or may be part of the memory device 120 in FIG. 1. In at least one embodiment, the data is stored in a memory buffer 216 within the GPU memory 214. Following the transfer, the data transfer functionality sends an ACK signal 218 from the DPU 130 to the GPU memory 214 to provide an indicator to the GPU(s) 104 that new data has been received from the DPU 130.

Elements within the GPU(s) 104 detect the completion of the data transfer (e.g., implemented using DMA). In at least one embodiment, a first Compute Unified Device Architecture (CUDA) kernel 222 performed by the GPU(s) 104 on the host side creates a Queue Pair (QP) dedicated to memory copy operations associated with the DMA engine (now shown) in the DPU 130 so that the DPU engine is exposed to the use of any application (e.g., CUDA tasks 230) performed by the GPU(s) 104. In at least one embodiment, a CUDA kernel for Polling On Data (referred to as a CUDA Polling On Data kernel 224) immediately detects the ACK signal 218 from the DPU 130 indicating that new data is stored in the GPU memory 214. The CUDA Polling On Data kernel 224 is provided with a specific location in the GPU memory 214 and size of the received data (e.g., the number of bytes). In at least one embodiment, GPU memory 214 is pre-allocated by the CPU 102 and the address is communicated to the remote peer before launching the CUDA kernel (e.g., the CUDA kernel 222). The location and size of that allocation is communicated to the DMA engine and/or the data transfer functionality for use thereby when performing data transfers. Similarly, the CPU 102 pre-allocates a memory location whereat the data transfer functionality (e.g., the DMA engine) may store the ACK signal 218.

In at least one embodiment, the CUDA kernel 222 acts as a proxy to receive the DMA data and performs a first stage analysis to then move only relevant/filtered/interesting data to whatever CUDA task is next. As such, other CUDA tasks/kernels do not require the DMA QP data as a reference. In this manner, the second CUDA kernel and the DMA engine may communicate with one another regarding memory copy operations. Alternatively, it is possible for the CPU 102 to pre-launch a CUDA kernel or CUDA tasks 230 such that the CUDA kernel of CUDA tasks are in a busy-waiting mode until the CUDA kernel 222 sends a notification to start processing the received data.

In at least one embodiment, the first CUDA kernel 222 is acting as a proxy receiving the TCP data via DMA transfer from the DPU 130 and sending the ACK signal 212 through the DMA to the DPU.

In at least one embodiment, a GPUNetIO library 226 provides functions that can be invoked by a CUDA kernel. In one embodiment, the GPUNetIO library 226 acknowledges receipt of the new data to the DPU 130, and provides feedback to the DPU 130 indicating that the GPU(s) 104 is/are ready to receive more data. For example, the GPUNetIO library 226 may send the ACK signal 212 to the DPU 130.

In at least one embodiment, the GPUNetIO library 226 is implemented as a DOCA GPUNetIO library that provides to the first CUDA kernel 222 a set of functions to create a work queue entry (WQE) in the QP, to create the WQE memory copy, and enqueue the WQE in the QP. The DOCA GPUNetIO library 226 may directly update a register in the DPU 130 to notify it that there is a new copy to be executed. In response, the DMA engine “wakes up,” reads the WQE memory copy and executes it.

In at least one embodiment, the first CUDA kernel 222 and/or a CUDA kernel 228 perform tasks, such as further analysis, processing, filtering (e.g., snort rules, regex, or the like), and/or selecting one or more portions of the data, files, and/or packets that may be relevant to the next CUDA task(s) (e.g., one or more of the CUDA tasks 230). In at least one embodiment, the CUDA tasks 230 may perform further operations on the received data. This may, for example, include security analysis for network security applications, process the data for artificial intelligence to detect specific features in the data. In another example, the CUDA tasks 230 can create retrieval-augmented generated (RAG) embeddings to store in a vector database. The GPU(s) 104 may perform other operations and the processing system 100 is not limited to these few examples.

In at least one embodiment, using the DPU 130 to handle TCP data permits the GPU(s) 104 to process TCP data in real-time. Each of the GPU(s) 104 may include a plurality of GPU cores 220. The GPU(s) 104 may perform the CUDA Polling on Data kernel 224 to immediately detect new data stored in the GPU memory 214. This entire process bypasses the host CPU and permits the host CPU to perform other tasks.

Thus, the application 132 performed by at least one processor of the DPU 130 may obtain the data packets 204 from the network adapter 126, obtain data transmitted by the data packets 204, and use the data transfer functionality (e.g., implemented by the DOCA DMA Plug-In 210) to store the data in the host GPU memory 214 and send the ACK signal 218 to set a flag indicating that new data has been stored in the host GPU memory 214. One or more functions (e.g., the CUDA Polling on Data kernel 224) performed by the GPU(s) 104 may poll the flag, and after determining that new data has been stored in the GPU memory 214, access the data, perform one or more processing operations with respect to the data, and send an acknowledgment (e.g., the ACK signal 212) to the DPU 130 indicating that the data was successfully accessed.

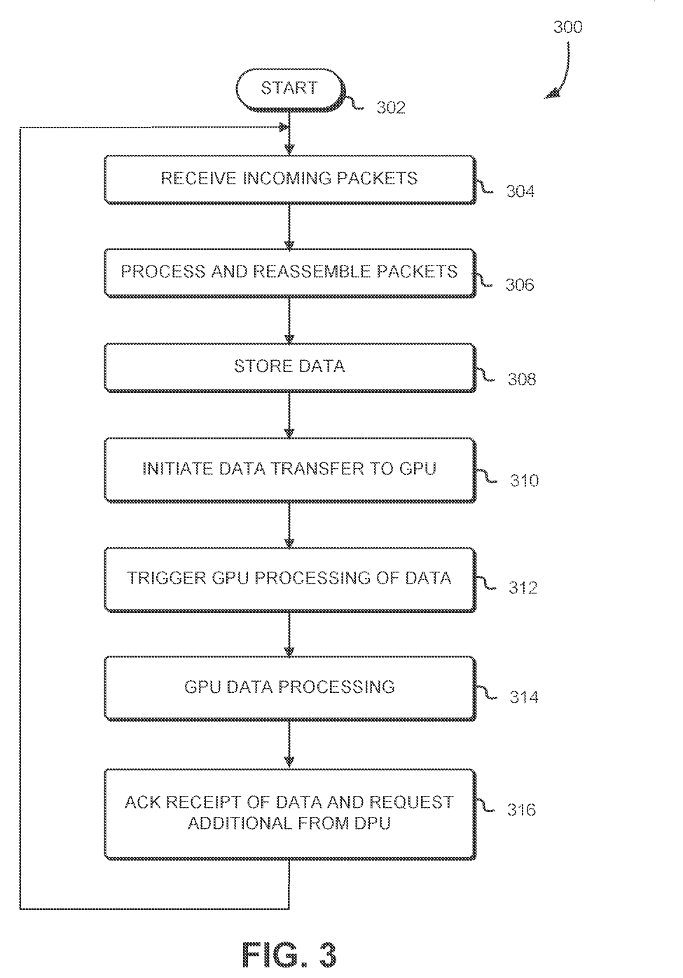

FIG. 3 is a flowchart illustrating a method 300, in accordance with at least one embodiment. The method 300 may be performed by the processing system 100 illustrated in FIGS. 1 and 2. At a start 302 (see FIG. 3), the processing system 100 is configured to receive and process incoming data. At block 304, a series of packets (e.g., the data packets 204) is received by the network adapter 126 connected to the DPU 130. The network adapter 126 interacts with the network 128 to receive the series of packets (e.g., the data packets 204) and interacts with the communication interface (e.g., the TCP/HTTP server 206) to transfer the series of packets for processing.

In block 306, the communication interface (e.g., the TCP/HTTP server 206) of the DPU 130 processes the incoming series of packets (e.g., the data packets 204) and reorders them, if necessary, to reassemble them into the original TCP frame and/or the original HTTP file. In block 308, the reassembled data is transferred to the memory 208 of the DPU 130 for temporary storage.

In block 310, the data transfer functionality (e.g., implemented by the DOCA DMA Plug-In 210) of the DPU 130 determines that the reassembled data is ready for transfer and initiates a transfer to the GPU memory 214. In at least one embodiment, the data transfer is a DMA transfer from the memory 208 to the GPU memory 214.

In block 312, the first CUDA kernel 222 (e.g., using the CUDA Polling on Data kernel 224) to detects the arrival of new data from the DPU 130 and begins processing the received data. In at least one embodiment, the CUDA Polling on Data kernel 224 uses polling to detect the arrival of new data.

In block 314, the first CUDA kernel 222 causes the GPU(s) 104 to process the newly received data, for example, by launching one or more CUDA kernels (e.g., one or more of the CUDA tasks 230). As noted above, the processing can include a wide range of applications, including, but not limited to, security processing, AI applications, graphics processing applications, etc.

In block 316, the first CUDA kernel causes a library (e.g., the GPUNetIO library 226) to generate an acknowledgment signal (e.g., the ACK signal 212) and sends the acknowledgment signal to the DPU 130. The acknowledgment signal is received by the DPU 130 and indicates to the DPU 130 that the GPU(s) 104 is ready for more data. The processing system 100 returns to block 304 to continued receiving and processing data packets.

Thus, the processing system 100 can offload the entire TCP processing from the host CPU (e.g., the processor(s) 102) to the DPU 130 thus saving processing cycles allowing the host CPU to perform other important processing tasks. As a result, the system 100 saves PCIe bandwidth and GPUs 104, functioning as the Host CPU, does not have to trigger expensive memory copies for every HTTP file/TCP payload from the CPU memory to the GPU memory 214.

FIG. 4A illustrates an example of a system 400 that includes one or more drivers and/or one or more runtimes (illustrated as reference numeral 404) including one or more libraries 406 to provide one or more application programming interfaces (“API(s)”) 410, in accordance with at least one embodiment. In at least one embodiment, the system 400 includes the driver(s) 404 and/or the runtime(s) 404 including the library(ies) 406 to provide to the API(s) 410. In at least one embodiment, the API(s) 410 is/are sets of software instructions that, if executed, cause one or more processors (e.g., processor(s) 422 illustrated in FIG. 4B) to perform one or more computational operations. In at least one embodiment, one or more of the API(s) 410 is/are distributed or otherwise provided as a part of one or more of the library(ies) 406, one or more of the runtime(s) 404, one or more of the driver(s) 404, and/or one or more component of any other grouping of software and/or executable code further described herein. In at least one embodiment, one or more of the API(s) 410 perform one or more computational operations in response to invocation by one or more software programs 402.

In at least one embodiment, one or more of the software program(s) 402 is/are a software module and/or include(s) one or more software modules. In at least one embodiment, a software module is as further illustrated non-exclusively in FIG. 4B as one or more modules 424 and described with respect thereto. In at least one embodiment, one or more of the software program(s) 402 is/are a collection of software code, commands, instructions, and/or other sequences of text to instruct a computing device (e.g., the DPU 130) to perform one or more computational operations and/or invoke one or more other sets of instructions, such as the API(s) 410 or API function(s) 412, to be executed by the computing device. In at least one embodiment, functionality provided by one or more of the API(s) 410 includes the API function(s) 412, such as those usable to accelerate one or more portions of the software program(s) 402 using one or more parallel processing units (PPUs), such as graphics processing units (e.g., the GPU(s) 104).

In at least one embodiment, one or more of the API(s) 410 is/are one or more hardware interfaces to one or more circuits to perform one or more computational operations. In at least one embodiment, one or more of the API(s) 410 described herein are implemented as one or more circuits to perform one or more techniques described in connection with FIGS. 1-3. In at least one embodiment, one or more of the software program(s) 402 include instructions that, if executed, cause one or more hardware devices and/or circuits to perform one or more techniques further described in connection with FIGS. 1-3. In at least one embodiment, the system 400 includes one or more or all components of the processing system 100 described in relation to FIG. 1, and the system 400 may perform one or more or all of the processes and/or operations that the systems and components of the processing system 100 perform.

In at least one embodiment, the software program(s) 402, such as user-implemented software programs, utilize one or more of the API(s) 410 to perform various computing operations, such as memory reservation, matrix multiplication, arithmetic operations, and/or any computing operation performed by PPUs, such as GPUs, as further described herein. In at least one embodiment, the function(s) 412 include a set of callable functions provided by one or more of the API(s) 410 that are referred to herein as APIs, API functions, software functions, and/or functions, that individually perform one or more computing operations, such as computing operations related to parallel computing. In at least one embodiment, one or more of the API(s) 410 perform the initial receipt of data packets (e.g., the data packets 204), and/or perform other operations described herein (e.g., in connection with FIGS. 1-3.

In at least one embodiment, one or more of the software program(s) 402 interact or otherwise communicate with one or more of the API(s) 410 to perform one or more computing operations using one or more processors (e.g., processor(s) 422 illustrated in FIG. 4B), such as one or more PPUs, such as GPUs. In at least one embodiment, one or more computing operations using one or more PPUs include at least one or more groups of computing operations to be accelerated by execution at least in part by said one or more PPUs. In at least one embodiment, one or more of the software program(s) 402 interact with one or more of the API(s) 410 to process the initial receipt of data packets (e.g., the data packets 204), and/or perform other operations described herein (e.g., in connection with FIGS. 1-3.

In at least one embodiment, an interface is software instructions that, if executed, provide access to one or more of the function(s) 412 provided by one or more of the API(s) 410. In at least one embodiment, one or more of the software program(s) 402 use(s) a local interface when a software developer compiles one or more of the software program(s) 402 in conjunction with one or more of the library(ies) 406 including or otherwise providing access to one or more of the API(s) 410. In at least one embodiment, one or more of the software program(s) 402 is/are compiled statically in conjunction with one or more pre-compiled ones of the library(ies) 406 and/or uncompiled source code including instructions to perform one or more of the API(s) 410. In at least one embodiment, one or more of the software program(s) 402 are compiled dynamically and the dynamically compiled software program(s) utilize a linker to link to one or more pre-compiled ones of the library(ies) 406, including one or more of the API(s) 410.

In at least one embodiment, one or more of the software program(s) 402 use(s) a remote interface when a software developer executes a software program that utilizes or otherwise communicates with at least one of the library(ies) 406 including one or more of the API(s) 410 over a network or other remote communication medium. In at least one embodiment, one or more of the library(ies) 406 including one or more of the API(s) 410 are to be performed by a remote computing service, such as a computing resource services provider. In at least one embodiment, one or more of the library(ies) 406 including one or more particular APIs (of the API(s) 410) is/are to be performed by any other computing host providing the particular API(s) to one or more of the software program(s) 402.

In at least one embodiment, a processor (e.g., processor(s) 422 illustrated in FIG. 4B) performing or using one or more particular ones of the software program(s) 402 calls, uses, performs, and/or otherwise implements one or more of the API(s) 410 to allocate and otherwise manage memory 414 to be used by the particular software program(s). In at least one embodiment, one or more particular ones of the software program(s) 402 utilize one or more of the API(s) 410 to allocate and otherwise manage the memory 414 to be used by one or more portions of the particular software program(s) to be accelerated using one or more PPUs, such as GPUs, or any other accelerator or processor further described herein. In at least one embodiment, one or more of the software program(s) 402 request one or more neural networks to perform signal processing using one or more of the function(s) 412 provided by one or more of the API(s) 410. In at least one embodiment, memory of the DPU 130 implements memory 414.

In at least one embodiment, one or more of the API(s) 410 is an API to facilitate parallel computing. In at least one embodiment, one or more of the API(s) 410 is any other API further described herein. In at least one embodiment, one or more of the API(s) 410 is/are provided by one or more of the driver(s) 404 and/or one or more of the runtime(s) 404. In at least one embodiment, one or more of the API(s) 410 is/are provided by a CUDA user-mode driver. In at least one embodiment, one or more of the API(s) 410 is/are provided by a CUDA runtime. In at least one embodiment, one or more of the driver(s) 404 is/are data values and software instructions that, if executed, perform and/or otherwise facilitate operation of one or more of the function(s) 412 of one or more of the API(s) 410 during load and execution of one or more portions of at least one of the software program(s) 402. In at least one embodiment, one or more of the runtime(s) 404 is/are data values and/or software instructions that, if executed, perform or otherwise facilitate operation of one or more of the function(s) 412 of one or more of the API(s) 410 during execution of at least one of the software program(s) 402. In at least one embodiment, one or more particular ones of the software program(s) 402 utilize one or more of the API(s) 410 implemented and/or otherwise provided by one or more of the driver(s) 404 and/or one or more of the runtime(s) 404 to perform combined arithmetic operations by the particular software program(s) during execution by one or more PPUs, such as GPUs.

In at least one embodiment, one or more of the software program(s) 402 utilize one or more of the API(s) 410 provided by one or more of the driver(s) 404 and/or one or more of the runtime(s) 404 to perform combined arithmetic operations of one or more PPUs, such as GPUs. In at least one embodiment, one or more of the API(s) 410 provide combined arithmetic operations through one or more of the driver(s) 404 and/or one or more of the runtime(s) 404, as described above. In at least one embodiment, one or more of the software program(s) 402 utilize one or more of the API(s) 410 provided by one or more of the driver(s) 404 and/or one or more of the runtime(s) 404 to allocate or otherwise reserve one or more blocks of the memory 414 of one or more PPUs, such as GPUs. In at least one embodiment, one or more of the software program(s) 402 utilize one or more of the API(s) 410 provided by one or more of the driver(s) 404 and/or one or more of the runtime(s) 404 to allocate or otherwise reserve blocks of the memory 414.

In at least one embodiment, to improve usability of one or more particular ones of the software program(s) 402 and/or improve performance, one or more portions of the particular software programs are to be accelerated by one or more PPUs (such as GPUs). In at least one embodiment, one or more of the function(s) 412 receive one or more input parameters indicating one or more inputs to one or more neural networks and/or other data to be utilized by the neural network(s), such as one or more hyperparameters of the neural network(s). In at least one embodiment, the input parameter(s) include the one or more inputs and/or the other data. In at least one embodiment, the input parameter(s) include one or more pointers to one or more memory locations where the input(s) and/or the other data is/are stored.

In at least one embodiment, the system 400 includes at least one processor (e.g., processor(s) 422 illustrated in FIG. 4B) including one or more circuits to perform one or more software programs to combine two or more of the API(s) 410 into a single API. In at least one embodiment, the system 400 includes at least one processor (e.g., processor(s) 422 illustrated in FIG. 4B) that uses one or more of the API(s) 410 to process the initial receipt of data packets (e.g., the data packets 204), and/or otherwise perform operations described herein. In at least one embodiment, the system 400 includes at least one processor (e.g., processor(s) 422 illustrated in FIG. 4B) that uses one or more of the API(s) 410 to perform one or more operations illustrated in and/or described with respect to one or more of FIGS. 1-3, such as one or more processes illustrated in FIGS. 1-2 or portion(s) thereof. In at least one embodiment, the system 400 includes at least one processor (e.g., processor(s) 422 illustrated in FIG. 4B) to perform one or more of the function(s) 412, such as those described in connection with FIGS. 1-3. In at least one embodiment, one or more of the API(s) 410 is to be performed by hardware described in connection with FIGS. 5-7.

FIG. 4B is block diagram 420 illustrating example processor(s) 422 and the module(s) 424, according to at least one embodiment. Referring to FIG. 4B, in at least one embodiment, the processor(s) 422 may be implemented by the GPU(s) 104 operating in conjunction with the DPU 130. In at least one embodiment, the processor(s) 422 may perform one or more processes such as those described herein with respect to the DPU 130 and the GPU(s) 104, and/or may otherwise perform operations described herein. In at least one embodiment, the processor(s) 422 perform(s) one or more processes such as those described in connection with FIGS. 1-3.

In at least one embodiment, the processor(s) 422 include one or more processors such as those described in connection with FIGS. 5-7. In at least one embodiment, processor(s) 422 may be any suitable processing unit and/or combination of processing units, such as one or more CPUs, GPUs, DPUs, GPGPUs, PPUs, and/or variations thereof. The processor(s) 422 includes the module(s) 424, which may include a software module 426 to control the network adapter 126, a software module 428 to implement the TCP/HTTP server, and a software module 430 to implement the DOCA DMA Plug-In. The module(s) 424 may be distributed among multiple processors that communicate over a bus, network, by writing to shared memory, and/or any suitable communication process such as those described herein. In at least one embodiment, the module(s) 424 may include processor executable instructions that implement the process of the initial intake of the data packets (e.g., the data packets 204), processing of the packets, and the transfer of the processed packets to the GPU(s) 104.

As used in any implementation described herein, unless otherwise clear from context or stated explicitly to contrary, a module refers to any combination of software logic, firmware logic, hardware logic, and/or circuitry configured to provide functionality described herein. Software may be embodied as a software package, code and/or instruction set or instructions, and “hardware,” as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. Modules may, collectively or individually, be embodied as circuitry that forms part of a larger system, for example, an integrated circuit (IC), system on-chip (SoC), and so forth. a module performs one or more processes in connection with any suitable processing unit and/or combination of processing units, such as one or more CPUs, GPUs, GPGPUs, DPUs, PPUs, and/or variations thereof.

In at least one embodiment, as used in any implementation described herein, unless otherwise clear from context or stated explicitly to contrary, terms such as “module” and nominalized verbs (e.g., image manager, image analyzer, analytics engine, controller, and/or other terms) each refers to any combination of software logic, firmware logic, hardware logic, and/or circuitry configured to provide functionality described herein. In at least one embodiment, software may be embodied as a software package, code and/or instruction set or instructions, and “hardware,” as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. In at least one embodiment, modules may, collectively or individually, be embodied as circuitry that forms part of a larger system, for example, an integrated circuit (IC), system on-chip (SoC), and so forth.

### LOGIC

FIG. 5A illustrates logic 515 which, as described elsewhere herein, can be used in one or more devices to perform operations such as those discussed herein in accordance with at least one embodiment. In at least one embodiment, logic 515 is used to perform inferencing and/or training operations associated with one or more embodiments. In at least one embodiment, logic 515 is inference and/or training logic. Details regarding logic 515 are provided below in conjunction with FIGS. 5A and/or 5B. In at least one embodiment, logic refers to any combination of software logic, hardware logic, and/or firmware logic to provide functionality or operations described herein, wherein logic may be, collectively or individually, embodied as circuitry that forms part of a larger system, for example, an integrated circuit (IC), system-on-chip (SoC), or one or processors (e.g., CPU, GPU).

In at least one embodiment, logic 515 may include, without limitation, code and/or data storage 501 to store forward and/or output weight and/or input/output data, and/or other parameters to configure neurons or layers of a neural network trained and/or used for inferencing in aspects of one or more embodiments. In at least one embodiment, logic 515 may include, or be coupled to code and/or data storage 501 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 501 may be included with other on-chip or off-chip data storage, including a processor’s L1, L2, or L3 cache or system memory.

In at least one embodiment, any portion of code and/or data storage 501 may be internal or external to one or more processors or other hardware logic devices or circuits. In at least one embodiment, code and/or code and/or data storage 501 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 501 is internal or external to a processor, for example, or including DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, logic 515 may include, without limitation, a code and/or data storage 505 to store backward and/or output weight and/or input/output data corresponding to neurons or layers of a neural network trained and/or used for inferencing in aspects of one or more embodiments. In at least one embodiment, code and/or data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, logic 515 may include, or be coupled to code and/or data storage 505 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 505 may be included with other on-chip or off-chip data storage, including a processor’s L1, L2, or L3 cache or system memory. In at least one embodiment, any portion of code and/or data storage 505 may be internal or external to one or more processors or other hardware logic devices or circuits. In at least one embodiment, code and/or data storage 505 may be cache memory, DRAM, SRAM, non-volatile memory (e.g., flash memory), or other storage. In at least one embodiment, a choice of whether code and/or data storage 505 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 501 and code and/or data storage 505 may be separate storage structures. In at least one embodiment, code and/or data storage 501 and code and/or data storage 505 may be a combined storage structure. In at least one embodiment, code and/or data storage 501 and code and/or data storage 505 may be partially combined and partially separate. In at least one embodiment, any portion of code and/or data storage 501 and code and/or data storage 505 may be included with other on-chip or off-chip data storage, including a processor’s L1, L2, or L3 cache or system memory.

In at least one embodiment, logic 515 may include, without limitation, one or more arithmetic logic unit(s) (“ALU(s)”) 510, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 520 that are functions of input/output and/or weight parameter data stored in code and/or data storage 501 and/or code and/or data storage 505. In at least one embodiment, activations stored in activation storage 520 are generated according to linear algebraic and or matrix-based mathematics performed by ALU(s) 510 in response to performing instructions or other code, wherein weight values stored in code and/or data storage 505 and/or data storage 501 are used as operands along with other values, such as bias values, gradient information, momentum values, or other parameters or hyperparameters, any or all of which may be stored in code and/or data storage 505 or code and/or data storage 501 or another storage on or off-chip.

In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor’s execution units or otherwise within a bank of ALUs accessible by a processor’s execution units either within same processor or distributed between different processors of different types (e.g., central processing units, graphics processing units, fixed function units, etc.). In at least one embodiment, code and/or data storage 501, code and/or data storage 505, and activation storage 520 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor’s L1, L2, or L3 cache or system memory. Furthermore, inferencing and/or training code may be stored with other code accessible to a processor or other hardware logic or circuit and fetched and/or processed using a processor’s fetch, decode, scheduling, execution, retirement and/or other logical circuits.

In at least one embodiment, activation storage 520 may be cache memory, DRAM, SRAM, non-volatile memory (e.g., flash memory), or other storage. In at least one embodiment, activation storage 520 may be completely or partially within or external to one or more processors or other logical circuits. In at least one embodiment, a choice of whether activation storage 520 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, logic 515 illustrated in FIG. 5A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates logic 515, according to at least one embodiment. In at least one embodiment, logic 515 is inference and/or training logic. In at least one embodiment, logic 515 may include, without limitation, hardware logic in which computational resources are dedicated or otherwise exclusively used in conjunction with weight values or other information corresponding to one or more layers of neurons within a neural network. In at least one embodiment, logic 515 illustrated in FIG. 5B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, logic 515 illustrated in FIG. 5B may be used in conjunction with central processing unit (CPU) hardware, graphics processing unit (GPU) hardware or other hardware, such as field programmable gate arrays (FPGAs). In at least one embodiment, logic 515 includes, without limitation, data storage 501 and code and/or data storage 505, which may be used to store code (e.g., graph code), weight values and/or other information, including bias values, gradient information, momentum values, and/or other parameter or hyperparameter information. In at least one embodiment illustrated in FIG. 5B, each of code and/or data storage 501 and code and/or data storage 505 is associated with a dedicated computational resource, such as computational hardware 502 and computational hardware 506, respectively. In at least one embodiment, each of computational hardware 502 and computational hardware 506 includes one or more ALUs that perform mathematical functions, such as linear algebraic functions, only on information stored in code and/or data storage 501 and code and/or data storage 505, respectively, result of which is stored in activation storage 520.

In at least one embodiment, each of code and/or data storage 501 and 505 and corresponding computational hardware 502 and 506, respectively, correspond to different layers of a neural network, such that resulting activation from one storage/computational pair 501/502 of code and/or data storage 501 and computational hardware 502 is provided as an input to a next storage/computational pair 505/506 of code and/or data storage 505 and computational hardware 506, in order to mirror a conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage/computation pairs 501/502 and 505/506 may be included in logic 515.

With respect to FIG. 5A, the data storage 501 and code and/or data storage 505 may be used to implement the drivers for the network adapter 126, the software for the TCP/HTTP server 206, and/or the DOCA DMA Plug-In 210. Similarly, with respect to FIG. 5B, the data storage 501 and code and/or data storage 505 may be used to implement the drivers for the network adapter 126, the software for the TCP/HTTP server 206, and/or the DOCA DMA Plug-In 210.

### DATA CENTER

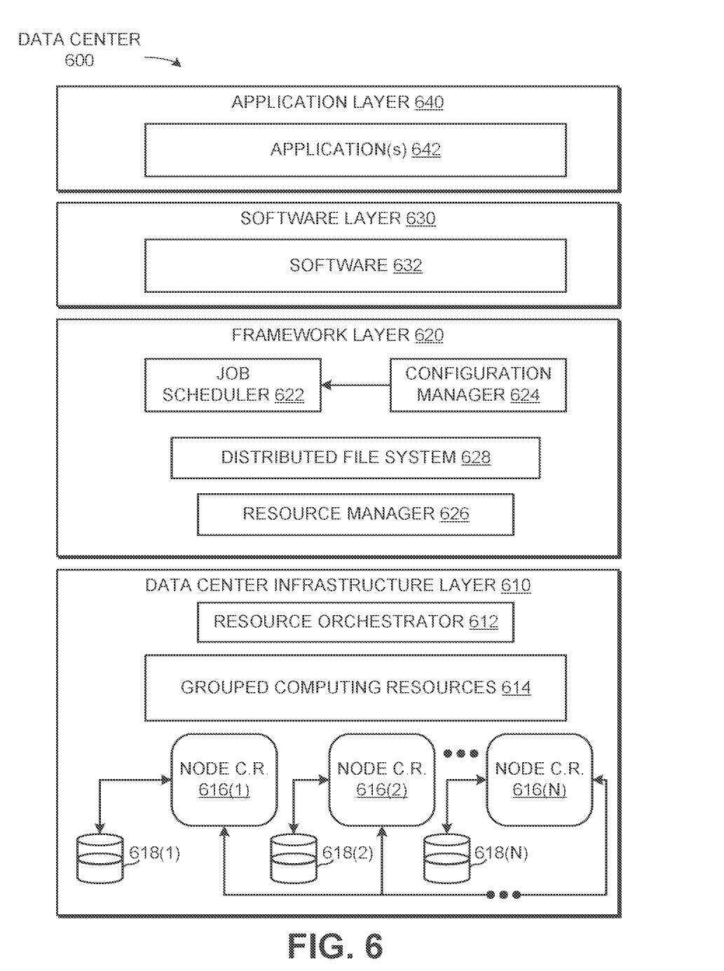

FIG. 6 illustrates an example data center 600, in which at least one embodiment may be used. In at least one embodiment, data center 600 includes a data center infrastructure layer 610, a framework layer 620, a software layer 630 and an application layer 640.

In at least one embodiment, as shown in FIG. 6, data center infrastructure layer 610 may include a resource orchestrator 612, grouped computing resources 614, and node computing resources (“node C.R.s”) 616(1)-616(N), where “N” represents a positive integer (which may be a different integer “N” than used in other figures). In at least one embodiment, node C.R.s 616(1)-616(N) may include, but are not limited to, any number of central processing units (“CPUs”) or other processors (including accelerators, field programmable gate arrays (FPGAs), graphics processors (e.g., the GPU(s) 104 of FIGS. 1-2), etc.), memory storage devices 618(1)-618(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources, such as the the GPU(s) 104, GPU memory 214, network adaptor 126, the DPU 130, and the like.

In at least one embodiment, grouped computing resources 614 may include separate groupings of node C.R.s housed within one or more racks (not shown), or many racks housed in data centers at various geographical locations (also not shown). In at least one embodiment, separate groupings of node C.R.s within grouped computing resources 614 may include grouped compute, network, memory or storage resources that may be configured or allocated to support one or more workloads. In at least one embodiment, several node C.R.s including CPUs or processors (e.g., the GPU(s) 104) may be grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for data center 600. In at least one embodiment, resource orchestrator 612 may include hardware, software or some combination thereof.

In at least one embodiment, as shown in FIG. 6, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 628 for large-scale data processing (e.g., “big data”). In at least one embodiment, job scheduler 622 may include a Spark driver to facilitate scheduling of workloads supported by various layers of data center 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resources 614 at data center infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. In at least one embodiment, one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

In at least one embodiment, data center 600 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 600. In at least one embodiment, trained machine learning models corresponding to one or more neural networks may be used to infer or predict information using resources described above with respect to data center 600 by using weight parameters calculated through one or more training techniques described herein.

In at least one embodiment, data center 600 may use CPUs, application-specific integrated circuits (ASICs), GPUs (e.g., the GPU(s) 104), FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Logic 515 are used to perform inferencing and/or training operations associated with one or more embodiments. Details regarding logic 515 are provided herein in conjunction with FIGS. 5A and/or 5B. In at least one embodiment, logic 515 may be used in data center 600 for inferencing or predicting operations based, at least in part, on weight parameters calculated using neural network training operations, neural network functions and/or architectures, or neural network use cases described herein.

With respect to FIG. 6, the data center 600 utilizes the shared data processing capabilities of a large number of processors to perform network processing tasks. The network requires communication between the various node C.R.s 616(1)-616(N). In at least one embodiment, communication between the node C.R.s may use TCP communication to transfer data. In at least one example, the GPU(s) 104 may receive data to perform a requested network processing task. In such a case, the DPU 130 is used as described above with respect to FIGS. 1-3 to process the TCP data and place the data in GPU memory (e.g., the GPU memory 214 in FIG. 2). As described herein one or more DPU(s) 130 may be used to process incoming TCP data from other node C.R.s (e.g., the node C.R.s 616(1)-616(N)) for delivery to the GPU(s) 104 so the GPU(s) may perform the requested network processing task. Upon completion of the network processing task, the GPU(s) 104 can use the DPU(s) 130 to process outgoing TCP data for transmission to other node C.R.s. The DPU 130 may be implemented as one portion of the processing system 100 of FIGS. 1-2, such as the DPU 130 and the GPUs 104 may be a portion of another processor 102 in the data center 600. Communication between the DPU 130 and the GPU(s) 104 may use internal communication links within the data center 600.

### COMPUTER SYSTEMS

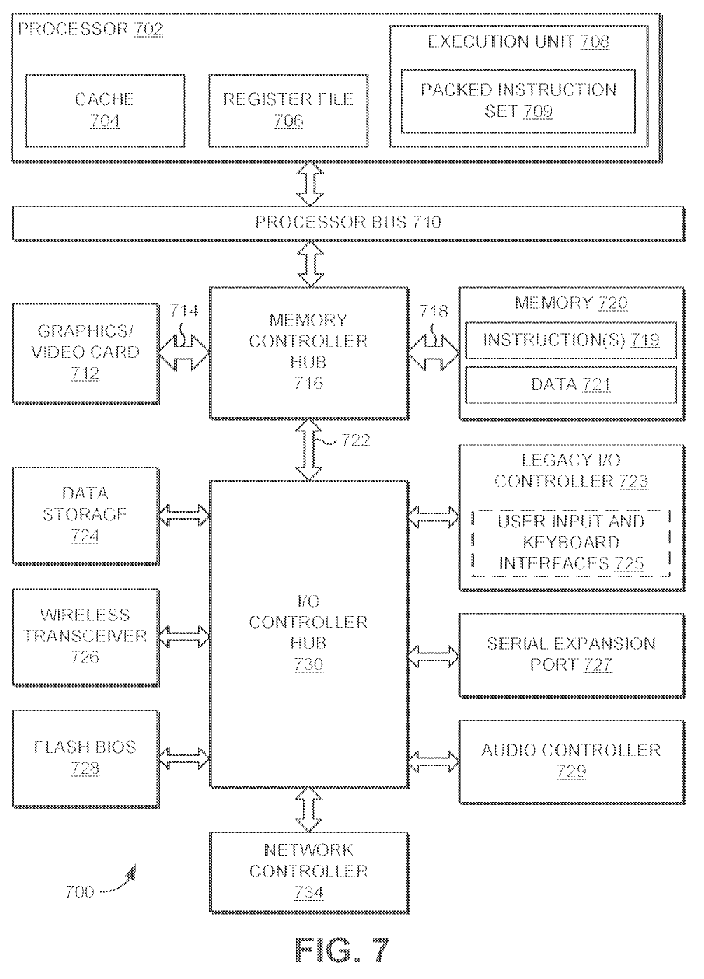

FIG. 7 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 700 may include, without limitation, a component, such as a processor 702 to employ execution units including logic to perform algorithms for process data, in accordance with present disclosure, such as in embodiment described herein. In at least one embodiment, computer system 700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 700 may include, without limitation, processor 702 that may include, without limitation, one or more execution units 708 to perform machine learning model training and/or inferencing according to techniques described herein. In at least one embodiment, computer system 700 is a single processor desktop or server system, but in another embodiment, computer system 700 may be a multiprocessor system. In at least one embodiment, processor 702 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, a GPU (e.g., the GPU(s) 104), a DPU (e.g., the DPU 130), or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. Other embodiments may also include a combination of both internal and external caches depending on particular implementation and needs. In at least one embodiment, a register file 706 may store different types of data in various registers including, without limitation, integer registers, floating point registers, status registers, and an instruction pointer register.

In at least one embodiment, execution unit 708, including, without limitation, logic to perform integer and floating point operations, also resides in processor 702. In at least one embodiment, processor 702 may also include a microcode (“ucode”) read only memory (“ROM”) that stores microcode for certain macro instructions. In at least one embodiment, execution unit 708 may include logic to handle a packed instruction set 709. In at least one embodiment, by including packed instruction set 709 in an instruction set of a general-purpose processor, along with associated circuitry to execute instructions, operations used by many multimedia applications may be performed using packed data in processor 702. In at least one embodiment, many multimedia applications may be accelerated and executed more efficiently by using a full width of a processor’s data bus for performing operations on packed data, which may eliminate a need to transfer smaller units of data across that processor’s data bus to perform one or more operations one data element at a time.

In at least one embodiment, execution unit 708 may also be used in microcontrollers, embedded processors, graphics devices, DSPs, and other types of logic circuits. In at least one embodiment, computer system 700 may include, without limitation, a memory 720. In at least one embodiment, memory 720 may be a Dynamic Random Access Memory (“DRAM”) device, a Static Random Access Memory (“SRAM”) device, a flash memory device, or another memory device. In at least one embodiment, memory 720 may store instruction(s) 719 and/or data 721 represented by data signals that may be executed by processor 702.

In at least one embodiment, a system logic chip may be coupled to processor bus 710 and memory 720. In at least one embodiment, a system logic chip may include, without limitation, a memory controller hub (“MCH”) 716, and processor 702 may communicate with MCH 716 via processor bus 710. In at least one embodiment, MCH 716 may provide a high bandwidth memory path 718 to memory 720 for instruction and data storage and for storage of graphics commands, data and textures. In at least one embodiment, MCH 716 may direct data signals between processor 702, memory 720, and other components in computer system 700 and to bridge data signals between processor bus 710, memory 720, and a system I/O interface 722. In at least one embodiment, a system logic chip may provide a graphics port for coupling to a graphics controller. In at least one embodiment, MCH 716 may be coupled to memory 720 through high bandwidth memory path 718 and a graphics/video card 712 may be coupled to MCH 716 through an Accelerated Graphics Port (“AGP”) interconnect 714.

In at least one embodiment, computer system 700 may use system I/O interface 722 as a proprietary hub interface bus to couple MCH 716 to an I/O controller hub (“ICH”) 730. In at least one embodiment, ICH 730 may provide direct connections to some I/O devices via a local I/O bus. In at least one embodiment, a local I/O bus may include, without limitation, a high-speed I/O bus for connecting peripherals to memory 720, a chipset, and processor 702. Examples may include, without limitation, an audio controller 729, a firmware hub (“flash BIOS”) 728, a wireless transceiver 726, a data storage 724, a legacy I/O controller 723 containing user input and keyboard interfaces 725, a serial expansion port 727, such as a Universal Serial Bus (“USB”) port, and a network controller 734. In at least one embodiment, data storage 724 may include a hard disk drive, a floppy disk drive, a CD-ROM device, a flash memory device, or other mass storage device.

In at least one embodiment, FIG. 7 illustrates a system, which includes interconnected hardware devices or “chips,” whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of computer system 700 are interconnected using compute express link (CXL) interconnects.

Logic 515 are used to perform inferencing and/or training operations associated with one or more embodiments. Details regarding logic 515 are provided herein in conjunction with FIGS. 5A and/or 5B. In at least one embodiment, logic 515 may be used in computer system 700 for inferencing or predicting operations based, at least in part, on weight parameters calculated using neural network training operations, neural network functions and/or architectures, or neural network use cases described herein.

With respect to FIG. 7, the processor 702 may be implemented as the DPU 130 in FIGS. 1 and 2. The network controller 734 is used to implement the network adapter 126 of FIGS. 1 and 2. Other elements of FIGS. 1-2, such as the TCP/HTTP server 206 and the DOCA DMA Plug-In 210 may be implemented as instructions 719 and data 721.

At least one embodiment of the disclosure can be described in view of the following clauses:

1. A data processing unit (DPU) comprising one or more circuits to obtain information transmitted in a plurality of transmission control protocol (TCP) data packets, and to store data, based at least in part on the information, in a graphics processing unit (GPU) memory.

2. The DPU of clause 1, wherein the one or more circuits are to reorder the TCP data packets to assemble the information into a data file, and the data is to comprise the data file.

3. The DPU of any of clauses 1 to 2, wherein the one or more circuits are to use a direct memory access (DMA) transfer protocol to store the data in the GPU memory.

4. The DPU of any of clauses 1 to 3, wherein the one or more circuits are to indicate to at least one GPU that the data has been stored in the GPU memory.

5. The DPU of any of clauses 1 to 4, wherein the one or more circuits are to receive an indication from at least one GPU to indicate that the at least one GPU successfully accessed the data stored in the GPU memory.

6. The DPU of any of clauses 1 to 5, wherein the one or more circuits are to receive an indication from at least one GPU to indicate that the at least one GPU is ready to receive additional data.

7. A system comprising memory, and at least one parallel processing unit (PPU) connected to the memory, and comprising one or more circuits to access data stored in the memory by a data processing unit (DPU) that was obtained by the DPU from a message transmitted in accordance with Transmission Control Protocol (TCP); and the one or more circuits to transmit an acknowledgement to the DPU indicating that the data has been accessed.

8. The system of clause 7, wherein the one or more circuits are to detect the data has been stored in the memory by the DPU before accessing the data.

9. A data center comprising a plurality of graphics processing units (GPUs), and a data processing unit (DPU) comprising a network adapter configured to receive a plurality of data packets, at least one server to receive the plurality of data packets and obtain processed data by processing the plurality of data packets, and a transfer engine to transfer the processed data to a memory of at least one of the plurality of GPUs.

10. The data center of clause 9, wherein the plurality of data packets comprise a plurality of transmission control protocol (TCP) data packets.

11. The data center of any of clauses 9-10, wherein the at least one server is to assemble a data file by reordering the TCP data packets, and the processed data is to comprise the data file.

12. The data center of any of clauses 9 to 11, wherein the transfer engine is to use a direct memory access (DMA) transfer protocol to store the processed data in the memory of the at least one GPU.

13. The data center of any of clauses 9 to 12, wherein the DPU is to indicate to the at least one GPU that the processed data has been stored in the memory of the at least one GPU.

14. The data center of any of clauses 9 to 13, wherein the DPU is to receive an indication from the at least one GPU to indicate that the at least one GPU is ready to receive additional data.

15. The data center of any of clauses 9 to 14, further comprising at least one computing system comprising the plurality of GPUs, the DPU, and at least one central processing unit (CPU), wherein the at least one server is to obtain the processed data without involving the CPU, and the transfer engine is to transfer the processed data to the memory without involving the CPU.

16. A method comprising obtaining, by at least one data processing unit (DPU). information transmitted in a plurality of transmission control protocol (TCP) data packets, and storing data by the at least one DPU, based at least in part on the information, in memory associated with a graphics processing unit (GPU).

17. The method of clause 16, wherein the at least one DPU is to reorder the TCP data packets to assemble the information into a data file, and the data is to comprise the data file.

18. The method of any of clauses 16 to 17, wherein storing the data comprises using a direct memory access (DMA) transfer protocol to store the data in the memory associated with the GPU.

19. The method of any of clauses 16 to 18, wherein the at least one DPU is to indicate to the GPU that the data has been stored in the memory associated with the GPU.

20. The method of any of clauses 16 to 19, wherein the at least one DPU is to receive an indication from the GPU to indicate that the GPU is ready to receive additional data.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, computer programs in form of machine-readable executable code or computer control logic algorithms are stored in main memory and/or secondary storage such as those described herein. Computer programs, if executed by one or more processors, enable at least one system described herein to perform various functions in accordance with at least one embodiment. In at least one embodiment, memory, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of a CPU such as those described herein, a parallel processing system such as those described herein, an integrated circuit capable of at least a portion of capabilities of both the CPU, the parallel processing system, a chipset (e.g., a group of integrated circuits designed to work and sold as a unit for performing related functions, etc.), and/or any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, a computer system described herein may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic. In at least one embodiment, a computer system includes or refers to any devices illustrated in any of the drawings and/or described herein.

In at least one embodiment, a parallel processing system includes, without limitation, a plurality of parallel processing units (“PPUs”) and associated memories. In at least one embodiment, PPUs are connected to a host processor or other peripheral devices via an interconnect and a switch or multiplexer. In at least one embodiment, a parallel processing system distributes computational tasks across the PPUs, which can be parallelizable — for example, as part of distribution of computational tasks across multiple graphics processing unit (“GPU”) thread blocks. In at least one embodiment, memory is shared and accessible (e.g., for read and/or write access) across some or all of the PPUs, although such shared memory may incur performance penalties relative to use of local memory and registers resident to a PPU. In at least one embodiment, operation of the PPUs is synchronized through use of a command such as __syncthreads(), wherein all threads in a block (e.g., executed across multiple PPUs) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation includes generating one or more machine-executable instructions, operations, or other signals from source code. In at least one embodiment, an API compiled into one or more instructions, operations, or other signals, when performed, causes one or more processors, such as graphics processors, graphics cores, parallel processor, a CPU, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors — for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system’s registers and/or memories into other data similarly represented as physical quantities within computing system’s memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A data processing unit (DPU) comprising:
one or more circuits to:
obtain information transmitted in a plurality of transmission control protocol (TCP) data packets; and
store data, based at least in part on the information, in a graphics processing unit (GPU) memory.

2. The DPU of claim 1, wherein the one or more circuits are to reorder the TCP data packets to assemble the information into a data file, and the data is to comprise the data file.

3. The DPU of claim 1, wherein the one or more circuits are to use a direct memory access (DMA) transfer protocol to store the data in the GPU memory.

4. The DPU of claim 1, wherein the one or more circuits are to indicate to at least one GPU that the data has been stored in the GPU memory.

5. The DPU of claim 1, wherein the one or more circuits are to receive an indication from at least one GPU to indicate that the at least one GPU successfully accessed the data stored in the GPU memory.

6. The DPU of claim 1, wherein the one or more circuits are to receive an indication from at least one GPU to indicate that the at least one GPU is ready to receive additional data.

7. A system comprising:
memory; and
at least one parallel processing unit (PPU) connected to the memory and comprising one or more circuits to:
access data stored in the memory by a data processing unit (DPU) that was obtained by the DPU from a message transmitted in accordance with Transmission Control Protocol (TCP); and
transmit an acknowledgement to the DPU indicating that the data has been accessed.

8. The system of claim 7, wherein the one or more circuits are to:
detect the data has been stored in the memory by the DPU before accessing the data.

9. A data center comprising:
a plurality of graphics processing units (GPUs); and
a data processing unit (DPU) comprising:
a network adapter configured to receive a plurality of data packets;
at least one server to receive the plurality of data packets and obtain processed data by processing the plurality of data packets; and
a transfer engine to transfer the processed data to a memory of at least one of the plurality of GPUs.

10. The data center of claim 9, wherein the plurality of data packets comprise a plurality of transmission control protocol (TCP) data packets.

11. The data center of claim 10, wherein the at least one server is to assemble a data file by reordering the TCP data packets, and the processed data is to comprise the data file.

12. The data center of claim 9, wherein the transfer engine is to use a direct memory access (DMA) transfer protocol to store the processed data in the memory of the at least one GPU.

13. The data center of claim 9, wherein the DPU is to indicate to the at least one GPU that the processed data has been stored in the memory of the at least one GPU.

14. The data center of claim 9, wherein the DPU is to receive an indication from the at least one GPU to indicate that the at least one GPU is ready to receive additional data.

15. The data center of claim 9, further comprising:
at least one computing system comprising the plurality of GPUs, the DPU, and at least one central processing unit (CPU), wherein the at least one server is to obtain the processed data without involving the CPU, and the transfer engine is to transfer the processed data to the memory without involving the CPU.

16. A method comprising:
obtaining, by at least one data processing unit (DPU). information transmitted in a plurality of transmission control protocol (TCP) data packets; and
storing, by the at least one DPU, data, based at least in part on the information, in memory associated with a graphics processing unit (GPU).

17. The method of claim 16, wherein the at least one DPU is to reorder the TCP data packets to assemble the information into a data file, and the data is to comprise the data file.

18. The method of claim 16, wherein storing the data comprises using a direct memory access (DMA) transfer protocol to store the data in the memory associated with the GPU.

19. The method of claim 16, wherein the at least one DPU is to indicate to the GPU that the data has been stored in the memory associated with the GPU.

20. The method of claim 16, wherein the at least one DPU is to receive an indication from the GPU to indicate that the GPU is ready to receive additional data.
